(19) United States
(12) Patent Application Publication
(10) Pub. No.: US 2012/0162459 A1
(43) Pub. Date: Jun. 28, 2012

(54) IMAGE CAPTURING APPARATUS AND IMAGE PATCHWORK METHOD THEREOF

(75) Inventor: SHIN-HAO CHENG, Taichung City (TW)

(73) Assignee: ALTEK CORPORATION, HSINCHU (TW)

(21) Appl. No.: 13/040,684

(22) Filed: Mar. 4, 2011

(30) Foreign Application Priority Data
Dec. 23, 2010 (TW) 099145646

(51) Int. Cl. H04N 5/228

(52) U.S. Cl. 348/222.1; 348/E05.031

(57) ABSTRACT

An image capturing apparatus and an image patchwork method are disclosed. The image capturing apparatus comprises an image capturing module and a processing module. The image capturing module captures a plurality of temporary images. The processing module is used to separate an image capturing window to form a plurality of image blocks, and control the image capturing apparatus to capture the temporary images according to the image blocks. The captured temporary images are patchworked sequentially into the image blocks by the processing module so as to generate a patchwork image.

### BACKGROUND OF THE INVENTION

1. Field of the Invention

The present invention relates to an image capturing apparatus and its method, and more particularly to an image capturing apparatus capable of creating personal image styles and its image patchwork method.

2. Description of the Related Art

Since the technology is gradually developed, an arrangement of a camera is continuously upgraded, and its functions gradually complete. Consumers do not only care the hardware specification of the camera, but also pay more attention on the operation functions of the camera, for example, how to beautify the captured pictures. In recent years, many cameras allow consumers to synthesize the stored pictures to generate funny pictures, such that pictures can be edited to add a decorative border.

While taking pictures, many people would like to take salon pictures in graceful landscapes. However, most conventional cameras are unable to take pictures for oneself at wide landscapes in one time due to their hardware restriction in lens or sensor. The only known manner of overcoming the foregoing problem is that user operates the conventional camera to respectively take pictures at many angles, and must further do post-process with the taken pictures to generate the synthetic pictures. This synthesis method requires skill and experience, and may not be suitable for non-professionals. Moreover, since the angles may not be easily handled, the synthesis quality is not ensured as well if the pictures are not taken with correct angles.

In addition, in a conventional patchwork picture, the picture is a panorama image. In another word, when the camera is switched to a patchwork mode, the user can take three or four pictures. The aforementioned pictures must continue the shooting angle of a previous picture so as to patchwork a wide and longer landscape picture.

Therefore, designing a useful image capturing apparatus and its image patchwork method to patchwork funny pictures or pictures with personal image styles become an important issue in market application.

### SUMMARY OF THE INVENTION

In view of the shortcomings of the prior art, the inventor(s) of the present invention based on years of experience in the related industry to conduct extensive researches and experiments, and finally developed an image capturing apparatus and its image patchwork method to create perfect images having personal features.

To achieve an objective, an image capturing apparatus provided by the invention comprises an image capturing module and a processing module. The image capturing module captures a plurality of temporary images. The processing module divides an image capturing window to form a plurality of image blocks and controls the image capturing module to capture the temporary images based upon the image blocks. The captured temporary images are sequentially patchworked by the processing module based upon the image blocks to generate a patchwork image.

The image capturing apparatus of the invention further comprises a touch module for receiving at least one touch signal and transmitting the touch signal to the processing module. The processing module divides the image capturing window based upon the touch signal.

The image capturing apparatus of the invention further comprises a storing module for storing at least one zoning template. The processing module divides the image capturing window based upon the zoning template.

The processing module further exchanges one of the temporary images with another temporary image.

The processing module zooms in or out, rotates, or moves the temporary images corresponding to each image block.

In addition, an image patchwork method is further provided and applied in the image capturing apparatus. The image patchwork method of the invention comprises the following steps. An image capturing window is divided through a processing module to form a plurality of image blocks. An image capturing module is controlled to capture a plurality of temporary images through the processing module. The temporary images sequentially are patchworked to the plurality of image blocks through the processing module to generate a patchwork image.

The dividing step is that at least one touch signal is received through a touch module and transmitted to the processing module. The image capturing window is divided through the processing module based upon the touch signal.

The dividing step is performed based upon at least one zoning template stored in a storing module so as to divide the image capturing window by the processing module.

The image patchwork method of the invention further comprises a step of utilizing a processing module to mutually exchange one of the temporary images with another temporary image.

The image capturing apparatus of the invention further comprises a step of utilizing the processing module to zoom in/out, rotate or move the plurality of temporary images.

In addition, the invention further provides an image capturing apparatus comprising a dividing module, an image capturing module and a processing module. The dividing module divides an image capturing window to form a plurality of image blocks. The image capturing module captures a plurality of temporary images. The processing module controls the image capturing module to capture the temporary images based upon these image blocks, and the processing module sequentially patchworks the captured temporary images based upon the image blocks to generate a patchwork image.

The image capturing apparatus of the invention further comprises a storing module for storing at least one zoning template so that the dividing module divides the image capturing window based upon at least one dividing template.

The image capturing apparatus of the invention and its image patchwork method of the invention have one or more advantages.
(1) Since the image capturing apparatus of the invention contains a touch module (e.g. a touch panel), the user can directly design multiple image blocks on the touch module, and simple operating gestures are utilized on the touch module to exchange, move, zoom in/out and rotate the temporary images corresponding to the image blocks, thereby achieving simple efficacy.
(2) In the image patchwork method of the invention, since the image blocks and the corresponding images can be freely designed, the advantage of personal image styles can be created so that the user can create images to provide unforgettable memory.

### BRIEF DESCRIPTION OF THE DRAWINGS

FIG. 1 is a block diagram of an image capturing apparatus according to an embodiment of the present invention;

FIG. 2A is a schematic diagram of an image capturing window according to an embodiment of the present invention;

FIG. 2B is a schematic diagram of an image capturing window according to another embodiment of the present invention;

FIG. 3 is a schematic diagram of an image capturing window and a temporary image display field according to an embodiment of the present invention;

FIG. 4 is a schematic diagram of mutually exchanging temporary images according to an embodiment of the present invention;

FIG. 5A is a schematic diagram of vertically moving temporary images according to an embodiment of the present invention;

FIG. 5B is a schematic diagram of zooming in or out temporary images according to an embodiment of the present invention;

FIG. 5C is a schematic diagram of rotating temporary images according to an embodiment of the present invention;

FIG. 6 is a schematic diagram of an image capturing window and an editing area according to an embodiment of the present invention;

FIG. 7 is a schematic diagram of an electronic device having image capturing function according to an embodiment of the present invention; and

FIG. 8 is a flowchart of an image patchwork method of the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

An image capturing apparatus of the invention can be portable electronic devices having image capturing functions such as a digital camera, a camera phone, a smartphone or a digital video camera. To further understand the technical features of the invention, the following embodiment takes the camera phone as an example, but does not limit the foregoing example.

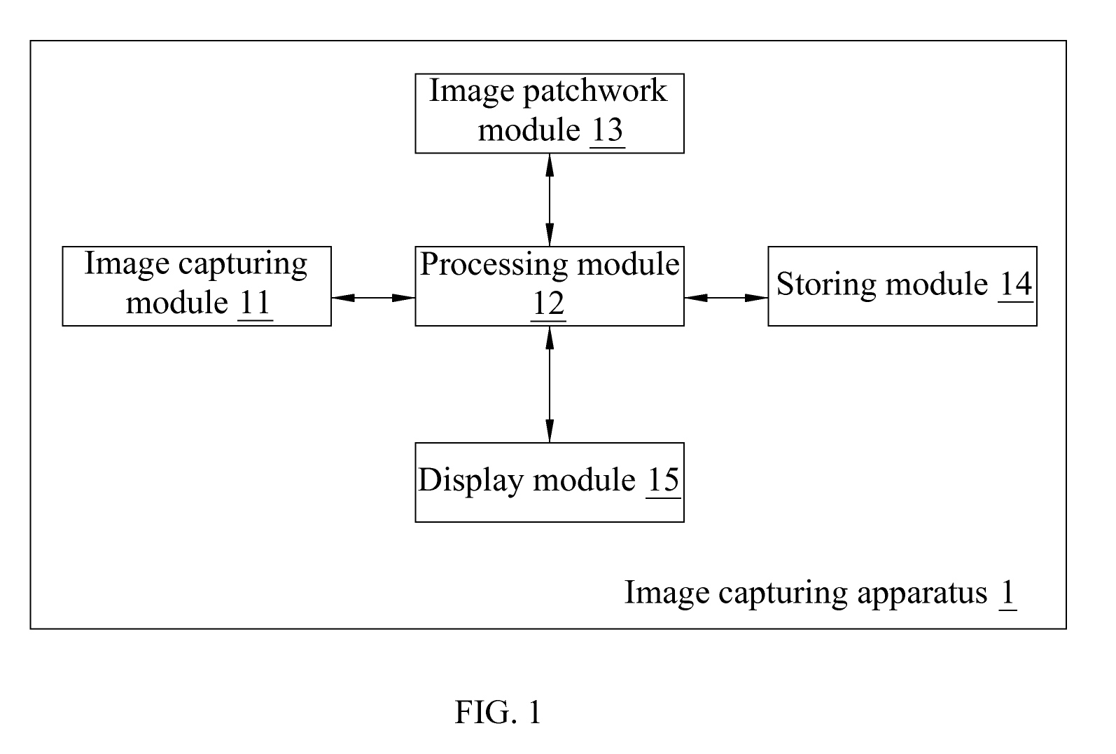

With the reference to FIG. 1 for a block diagram of an image capturing apparatus in accordance with an embodiment of the invention is depicted. As shown in the figure, the image capturing apparatus 1 of the invention comprises an image capturing module 11, a processing module 12, an image patchwork module 13, a storing module 14 and a display module 15. The image capturing module 11 is used for capturing images and generating image data. The image capturing module 11 can comprises a lens, a photosensing element such as a complementary metal-oxide-semiconductor (CMOS) or a charge-coupled-device (CCD), an analog/digital circuit, an image processor and etc. The storing module 14 is used to store images, softwares capable of being executed by the processing module 12, and related data. Preferably, the storing module 14 can be an embedding memory, an external memory card or a combination thereof. The display module 15 is used for displaying images and can be, but not limited, a liquid crystal display or a touch liquid crystal display.

The processing module 12 is electrically connected to the image capturing module 11, the image patchwork module 13, the storing module 14 and the display module 15. The processing module 12 can be a central processing unit (CPU) or a micro-processing unit. The processing module 12 can execute a dividing function to generate an image capturing window to form a plurality of image blocks and control the image capturing module 11 to capture a plurality of temporary images based upon the image blocks. The processing module 12 controls the image patchwork module 13 to sequentially patchwork these temporary images based upon these image blocks, thereby producing a patchwork image. The patchwork images can be saved in the storing module 14 or display the patchwork image through the display module 15. In addition, the dividing function executed by the processing module 12 can be achieved by a block module (not shown in the figure). Those skilled in the art can randomly combine the foregoing function modules into an integrated module or disassemble the modules into each functional unit based upon desire design. Moreover, the image patchwork module 13 can be software program installed in an operating system.

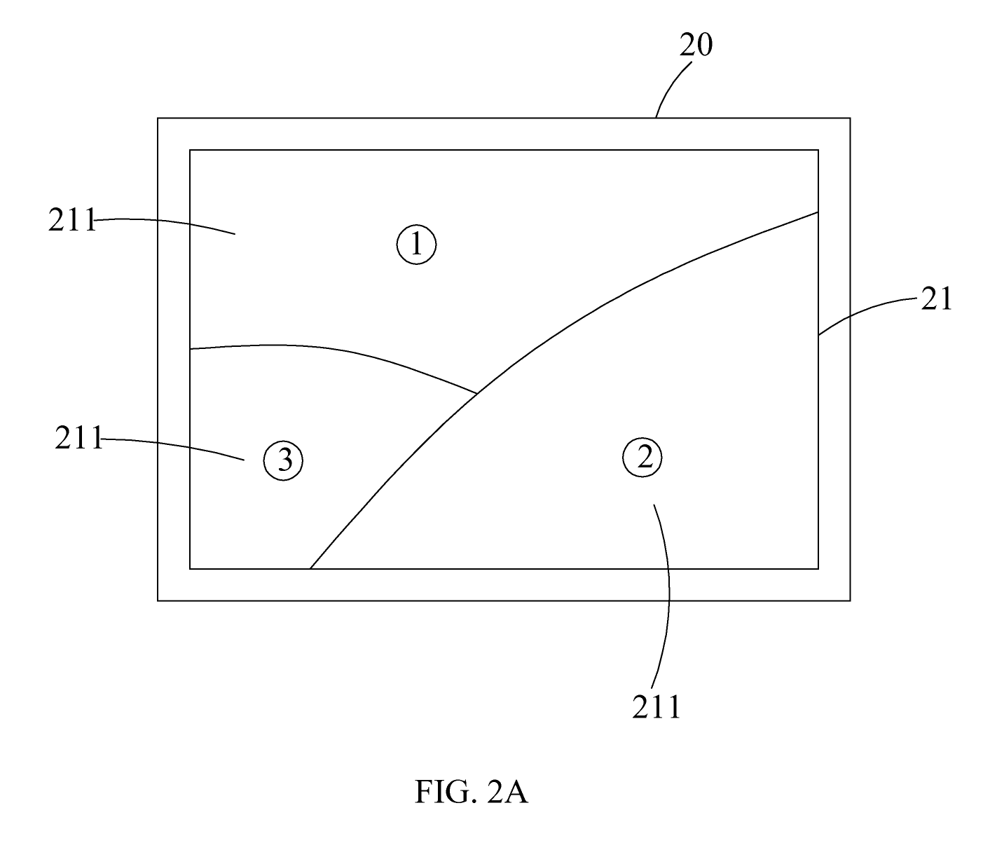

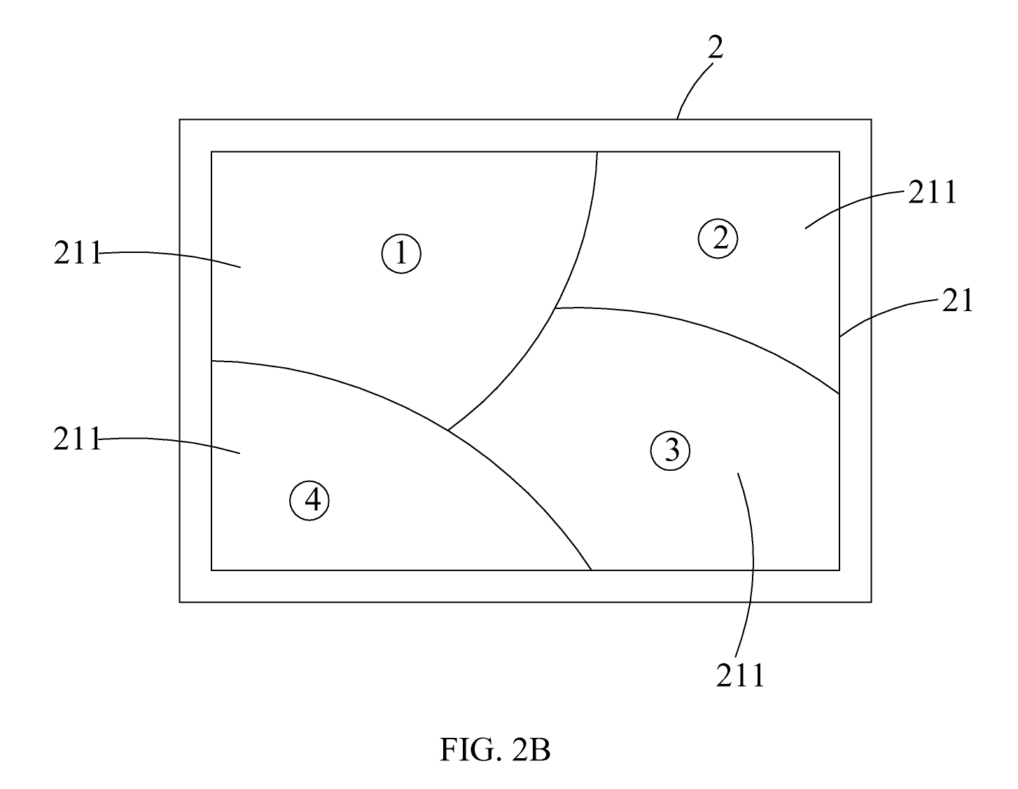

The image capturing window can be provided by the display module 15 or a viewfinder of a normal camera. As shown in FIG. 2A, when the image capturing window 21 is provided by the viewfinder 20, the processing module 12 can divide the image capturing window 21 into a plurality of image blocks 211, and assign an order to these image blocks 211. For instance, when three image blocks 211 are formed, the upper image block is numbered as \textcircled{1}, and the other image blocks are clockwisely and sequentially numbered as \textcircled{2} and \textcircled{3}. The user can capture the temporary image through the viewfinder 20. For instance, while taking the image block 211 numbered as \textcircled{1}, the image blocks 211 numbered as \textcircled{2} and \textcircled{3} can be transformed into fog state or other visual display effects so that the user can clearly know that the temporary image will be put to the image block 211 numbered as \textcircled{1}.

Moreover, when the display module 15 is provided by the touch module (a touch display monitor 2 shown in FIG. 2B), the user directly utilizes the touch display monitor 2 to input at least one touch signal that is a signal of the divided image capturing window 21 to allow the image capturing window 21 to form the plurality of image blocks 211. The user divides the image capturing window 21 into four image blocks 211, and the four image blocks 211 have orders and can be set by the user. In FIG. 2B, the image block 211 at a left corner is numbered as \textcircled{1}, and other image blocks 211 are respectively numbered as \textcircled{2}, \textcircled{3}, and \textcircled{4} by clockwise counting. After the user uses the image capturing module 11 to capture four temporary images, the processing module 12 replaces the image blocks \textcircled{1} to \textcircled{4} based upon sequential picture taking time. In another word, the first image captured by the user at the earliest is placed into the image block \textcircled{1}, and the later temporary images are sequentially placed and there is no need to depict herein. Further, the mode of processing the temporary images can be the same as the foregoing embodiment. While capturing the temporary images corresponding to the image block 211 numbered as \textcircled{1}, other image blocks 211 become a fog state or other visual display effects to enable the user to clearly know that the temporary images to be currently taken will be placed to the image block 211 numbered as \textcircled{1}. In addition, the mode of processing the temporary images can be instantly displayed to the corresponding image blocks 211 after capturing the temporary images to allow the user to quickly browse the captured temporary images.

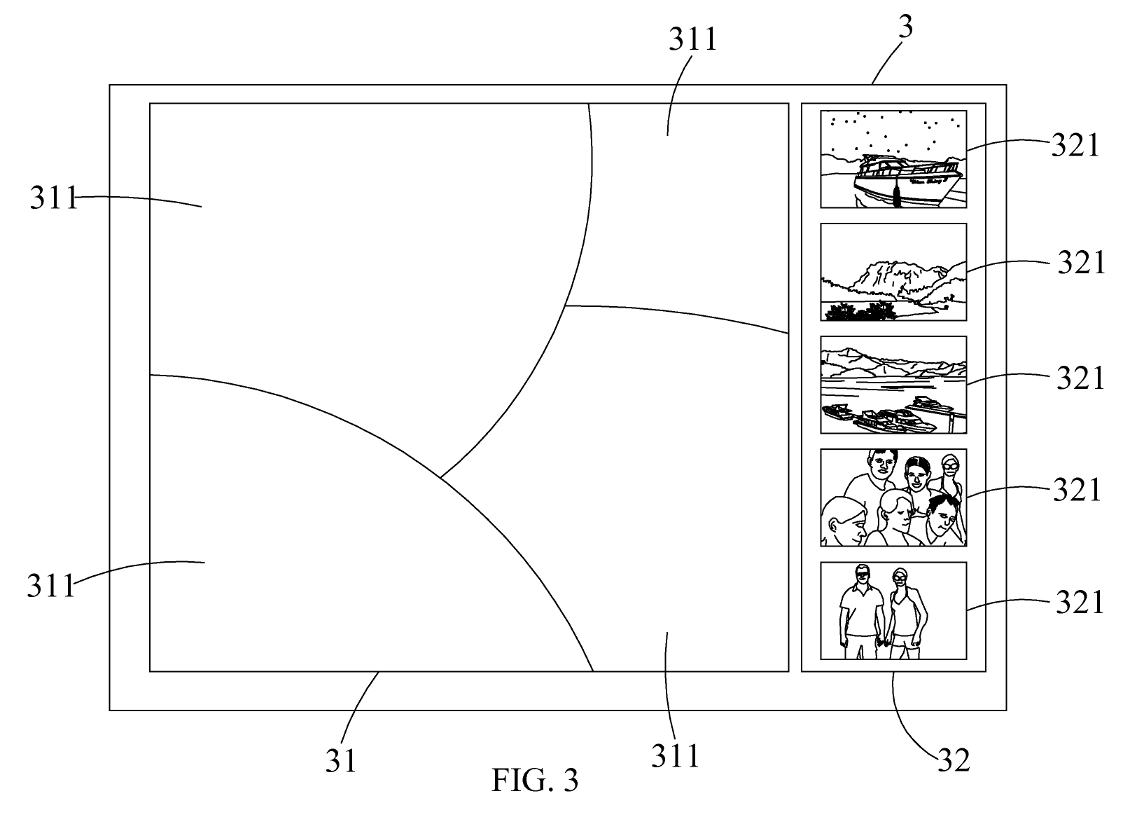

In another embodiment, with reference to FIG. 3 for a schematic diagram of an image capturing window and a temporary image display field in accordance with an embodiment of the invention is depicted. The touch display monitor 3 can be divided into an image capturing window 31 and the temporary image display field 32. The image capturing window 31 can be divided into the image blocks 311 based upon user's preference. In the embodiment, the image capturing window 31 is divided into four image blocks 311. Herein each image block 311 does not have order. The user utilizes the image capturing module 11 to capture a plurality of temporary images 321. In the present embodiment, five temporary images 321 are taken, but not limited to, and the five temporary images 321 will be displayed on the temporary image display field 32. While patchworking the images, the user directly drags the temporary image 321 to be placed into the image block 311 of the touch display monitor 3. Therefore, a patchwork image is obtained upon the user's preference. The difference between the embodiment and the foregoing embodiment is that the image blocks 311 of the embodiment do not have orders. The user can freely and randomly drags the captured temporary images 321 to the image blocks 311 to further complete the patchwork image with personal styles.

In addition, the storing module 14 of the image capturing apparatus of the invention is further stored with at least one zoning template that is provided with the quantity and arrangement for predetermined image blocks. The user can select the zoning template to be applied from the storing module 14. Thus, there is no need to divide the image capturing window, and the image capturing module 11 can be directly utilized to capture the temporary image. Alternatively, the storing module 14 also stores other cartoon patterns, landscape pictures or other interested pictures. The user can further select cartoon patterns to patchwork the temporary images of real objects to increase an interest with respect to the patchwork images.

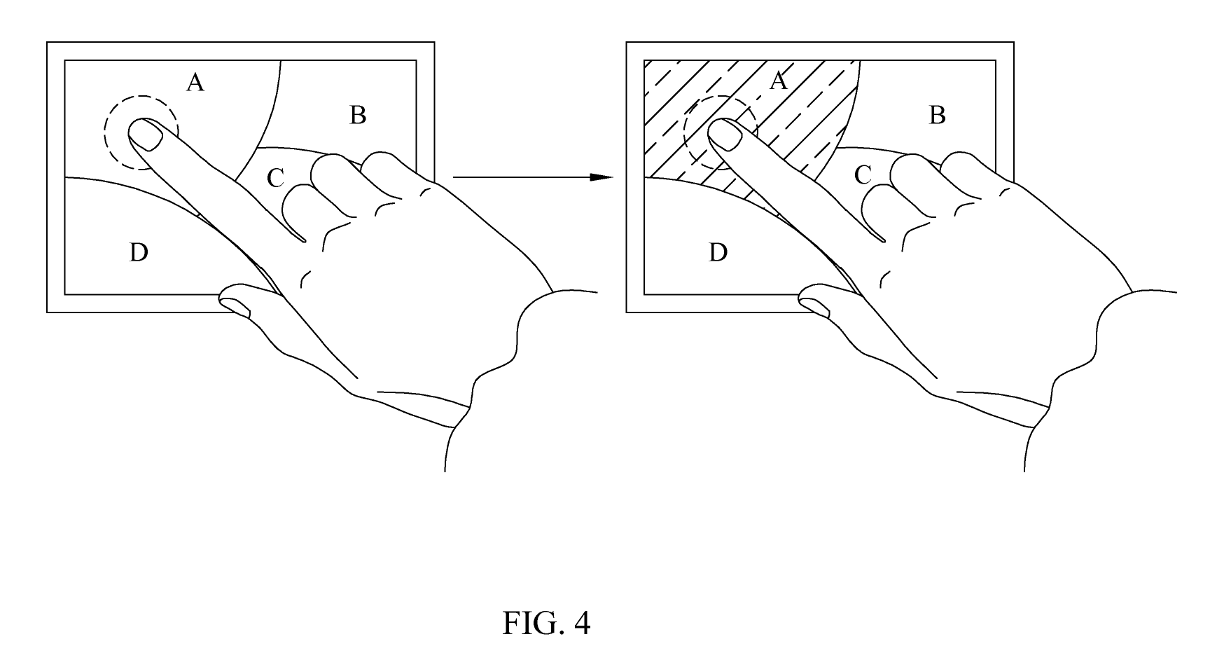

In the foregoing embodiments, the processing module 12 further exchanges any temporary image and another temporary image. For instance, the image capturing window is provided by the touch display monitor (but does not limit to), and the image capturing window is divided into four image blocks. To conveniently explanation, each image block of the invention at the left corner is sequentially numbered as A, B, C and D based upon clockwise. When the image block A is exchanged with the image block B, the user can click the image block A and press it for three seconds. The image block A appears a mask as shown in FIG. 4. In the meantime, the user then selects the image block B to exchange the temporary images.

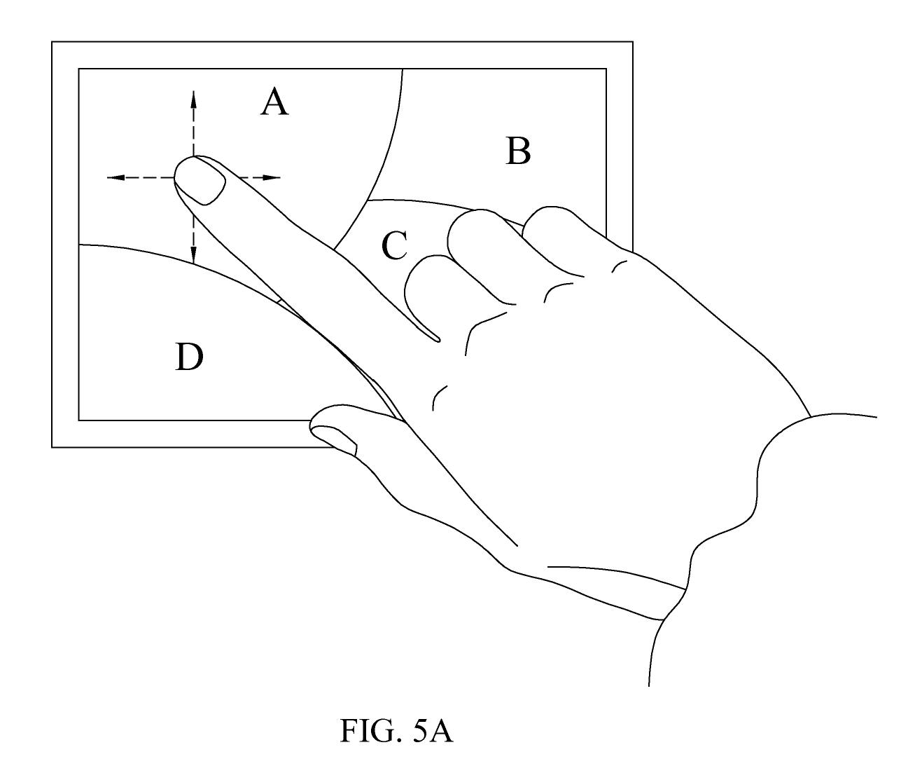

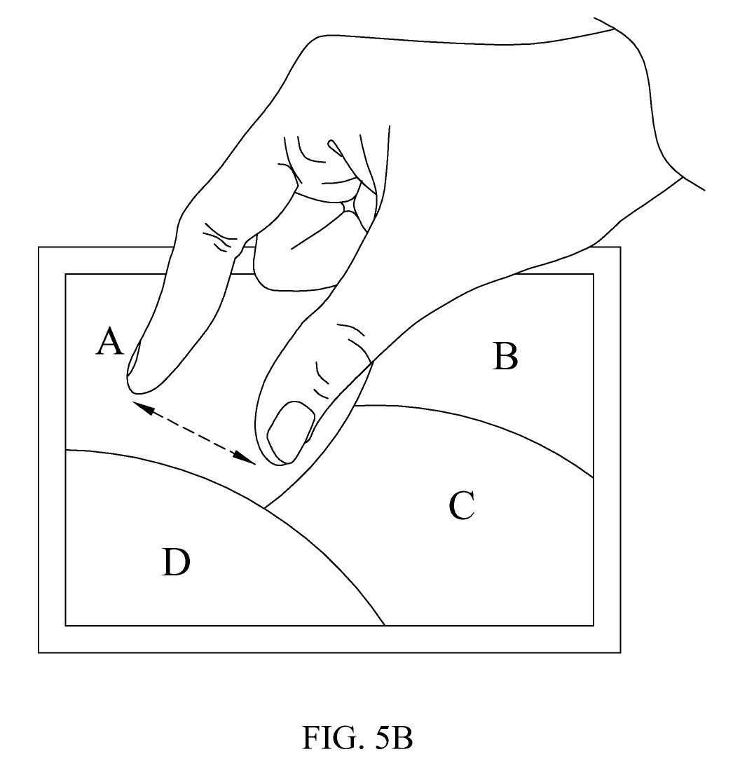

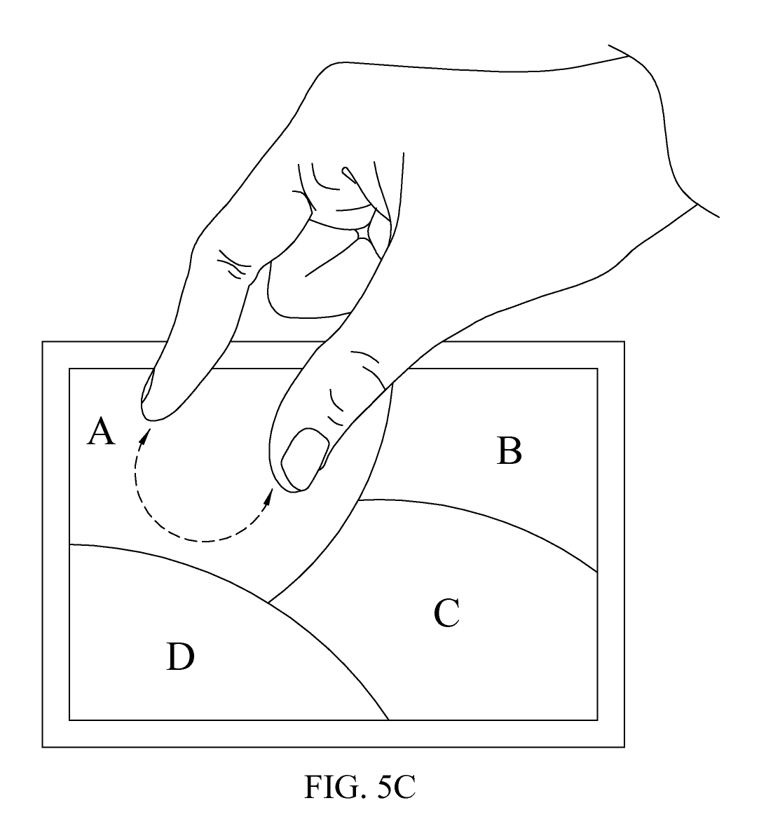

In addition, the processing module 12 further zooms out, zooms in, rotates or moves the temporary images corresponding to any image block. In the embodiment, the touch display monitor is taken as an example. While moving the temporary images, the user can directly touch the temporary image to be moved. Next, the temporary image is moved around as shown in FIG. 5A. Therefore, the temporary image can be moved within a designated image block.

With reference to FIG. 5B for a schematic diagram of zooming in or out the temporary image in accordance with an embodiment of the invention is depicted. As shown, while zooming in or out the temporary image, two fingers (such as a thumb and a forefinger) put on the image block of the temporary image to be zoomed in or out. When the fingers stagger, the temporary image is zoomed in. Otherwise, when the fingers close, the temporary image is zoomed out. When the temporary image needs to be rotated, the user puts his/her two fingers, whose separated distance is not changed, on the temporary image to be rotated. The temporary image can be rotated by rotating left or right (as shown in FIG. 5C).

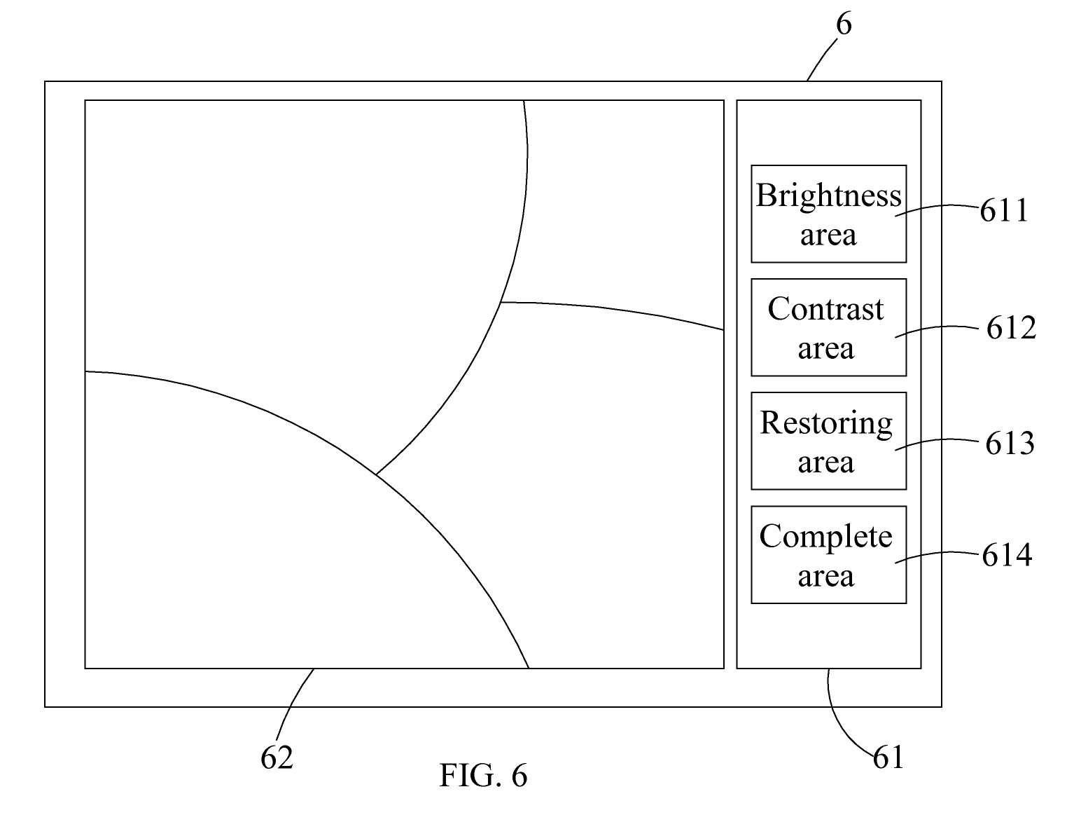

In addition, when the image capturing window is shown by the touch display monitor, the touch display monitor further has an editing area as shown in FIG. 6. The editing area 61 can contain icons (including patterns and texts) for regulating brightness or contrast. As the embodiment shown in FIG. 6, the texts are used as icons but not limited thereto. The editing area 61 contains a brightness area 611, a contrast area 612, a restoring area 613 and a complete area 614. For instance, the user can select the temporary image to be regulated with brightness or contrast. The brightness and contrast of the temporary image can be controlled by utilizing the brightness area 611 or the contrast area 612. While completing the entire editing, the complete area 614 is selected to display the patchwork image, which has been edited, on the image capturing window 62, and the patchwork image is stored in the storing module. The foregoing embodiment is, but not limit to, an instance only.

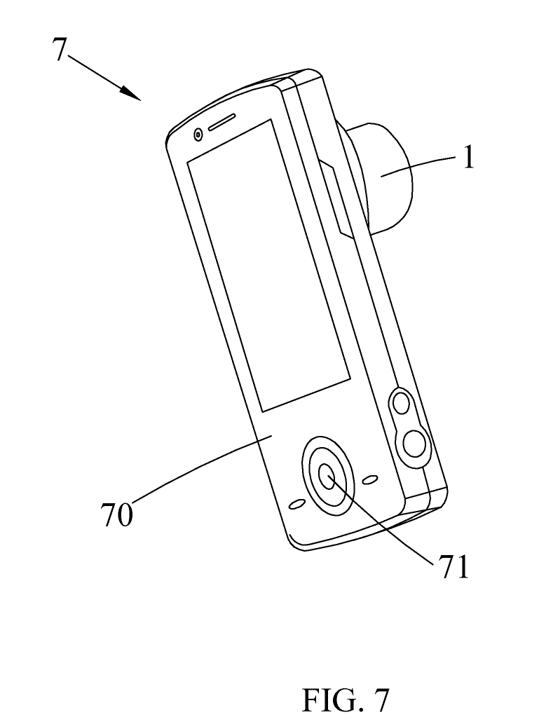

With reference to FIG. 7 for a schematic diagram of an electronic apparatus having image capturing function in accordance with an embodiment of the invention is depicted. As shown, the electronic apparatus 7 of the invention comprises a main body 70, an input device 71 and an image capturing apparatus 1. The image capturing apparatus 1 is installed on the main body 70 and electrically connected to the input device 71. The image capturing apparatus 1 comprises an image capturing module, an exposure module, a processing module, an image patchwork module, a storing module and a display module. The detail depiction of the image capturing apparatus 1 is previously provided, and therefore is not described again herein. However, the electronic apparatus 7 provided by the invention can be different types of mobile hand-held apparatus such as a digital camera, a multimedia broadcast device having photo-taking function, a mobile phone having photo-taking function, a smart phone, a navigator, a tablet computer or a personal digital assistant (PDA) having photo-taking function.

In the embodiment, the electronic apparatus 7 of the invention takes the smart phone as an instance. The image capturing apparatus 1 provided by the invention can be built in the smart phone to take pictures. The user then uses the input device 71 of the smart phone such as the touch screen or real buttons. When the user would like to patchwork the images, the zoning template originally stored in the storing module can be displayed on the display screen to intercept the temporary images. The subsequent steps are as well as the foregoing steps, and detail depiction is not repeated. Those ordinary skilled in the art could easily replace other devices by incorporating with the image capturing apparatus of the invention.

Although the concept of the image patchwork method of the image capturing apparatus is simultaneously depicted in the foregoing embodiment, the flowchart is further provided for detail depiction.

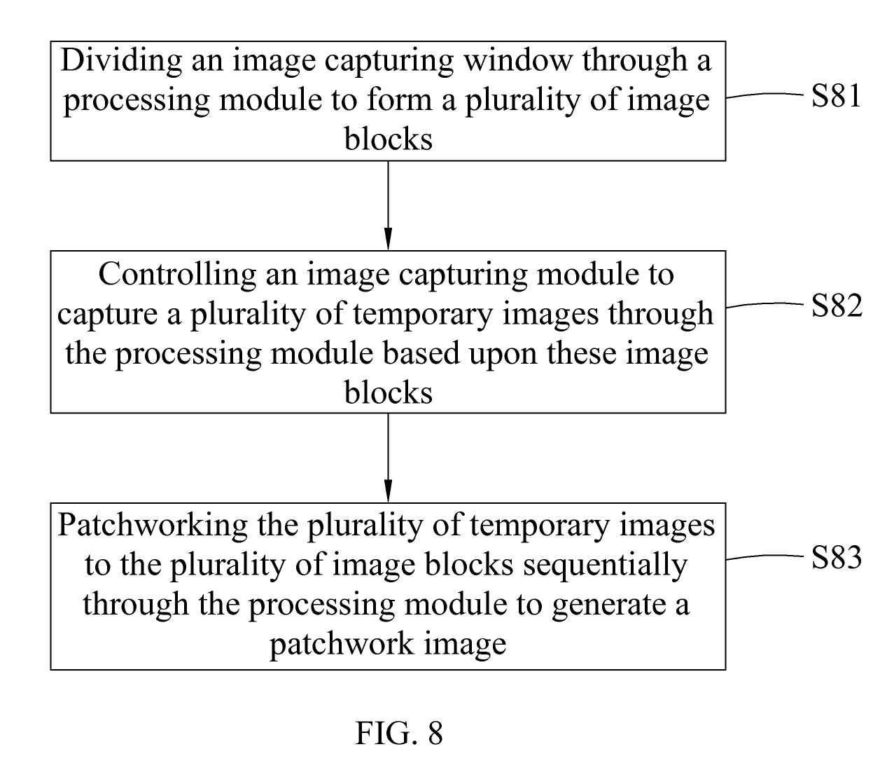

With reference to FIG. 8 for a flowchart of an image patchwork method in accordance with the invention is depicted. As shown in the figure, the image patchwork method of the invention is applied in an image capturing apparatus. The image patchwork method of the image capturing apparatus comprises the following steps. In step S81, an image capturing window is divided through a processing module to form a plurality of image blocks. In step S82, an image capturing module is controlled to capture a plurality of temporary images through the processing module based upon these image blocks. In step S83, the temporary images are patchworked to the plurality of image blocks sequentially through the processing module to generate a patchwork image.

The detail depiction and implementation manner of the image patchwork method of the image capturing apparatus provided by the invention have been depicted in the image capturing apparatus and electronic devices. Detail depiction herein is unnecessary.

To sum up, since the image capturing apparatus of the invention contains a touch module, the user can directly design multiple image blocks on the touch module. Simple operating gestures are utilized on the touch module to exchange, move, zoom in/out and rotate the temporary images corresponding to the image blocks, thereby achieving simple efficacy. In addition, in the image patchwork method of the invention, since the image blocks and the corresponding images can be freely designed, the advantage of personal image styles can be created so that the user can create images to provide unforgettable memory.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. An image capturing apparatus comprising:
an image capturing module capturing a plurality of temporary images; and
a processing module dividing an image capturing window to form a plurality of image blocks, and controlling the image capturing module to capture the plurality of temporary images based upon the image blocks, the processing module sequentially patchworking the temporary images based upon the image blocks to generate a patchwork image.

2. The image capturing apparatus as recited in claim 1, further comprising a touch module receiving at least one touch signal, wherein the processing module divides the image capturing window based upon the at least one touch signal.

3. The image capturing apparatus as recited in claim 1, further comprising a storing module for storing at least one zoning template, wherein the processing module divides the image capturing window based upon the at least one zoning template.

4. The image capturing apparatus as recited in claim 1, wherein one of the temporary images and another temporary image are exchanged each other by the processing module.

5. An image patchwork method applied in an image capturing apparatus, the image patchwork method comprising the following steps:
dividing an image capturing window by using a processing module to form a plurality of image blocks;
controlling an image capturing module to capture a plurality of temporary images by using the processing module based upon the image blocks; and
sequentially patchworking the plurality of temporary images to the plurality of image blocks by using the processing module to generate a patchwork image.

6. The image patchwork method as recited in claim 5, wherein the dividing step further comprises receiving at least one touch signal through a touch module and transmitting the touch signal to the processing module so as to divide the image capturing window by the processing module based upon the at least one touch signal.

7. The image patchwork method as recited in claim 5, wherein the step of dividing the image capturing window through the processing module is performed based upon at least one zoning template stored in a storing module.

8. The image patchwork method as recited in claim 5, further comprising a step of exchanging one of the temporary images and another temporary image each other through the processing module.

9. An image capturing apparatus comprising:
a dividing module dividing an image capturing window to form a plurality of image blocks;
an image capturing module capturing a plurality of temporary images; and
a processing module controlling the image capturing module to capture the temporary images based upon the image blocks; the processing module sequentially patchworking the temporary images based upon the image blocks to generate a patchwork image.

10. The image capturing apparatus as recited in claim 9, further comprising a storing module storing at least one zoning template, wherein the processing module divides the image capturing window based upon the at least one zoning template.
